(19) United States
(12) Patent Application Publication
(10) Pub. No.: US 2022/0411312 A1
(43) Pub. Date: Dec. 29, 2022

(54) METHOD OF FORMING A FLAT GLASS INTO A GLASS COMPONENT AND FORMING TOOL FOR USE IN THE METHOD

(71) Applicant: FLABEG AUTOMOTIVE GERMANY GMBH, Furth im Wald (DE)

(72) Inventors: Thomas HOING, Michelsdorf (DE); Damien CZWALINNA, Hostauer Strabe (DE); Julia WALLNER, Stadplatz (DE); Christian FRANZ, Von-Voitheberg-Strabe (DE)

(73) Assignee: FLABEG Automotive Germany GmbH, Furth im Wald (DE)

(21) Appl. No.: 17/771,833

(22) PCT Filed: Oct. 5, 2020
(86) PCT No.: PCT/EP2020/077811

§ 371 Date: Apr. 26, 2022

(30) Foreign Application Priority Data
Oct. 31, 2019 (DE) 10 2019 216 893.0

(51) Int. Cl. C03B 23/025; C03B 40/02

(52) U.S. Cl. CPC C03B 23/0258; C03B 40/02; C03B 23/0357

(57) ABSTRACT

A method for forming a flat glass into a glass component, the glass component comprising a base surface and provided with a number of formations for forming surface structural elements that can be felt by a user, is intended to ensure a particularly high mechanical load-bearing capacity of the glass component or moulded part in a particularly simple and reliable manner, even in the case of comparatively complexly configured structural elements. For this purpose, according to the invention, the flat glass is placed in a forming tool on a number of forming plungers corresponding to the intended formations and then heated to soften the material, so that the glass material assumes the contour of the base of the forming tool between the forming plungers for forming the base area.

### CROSS-REFERENCE TO RELATED APPLICATIONS

This application is a national stage application of the Patent Cooperation Treaty (PCT) international application titled “Method For Shaping A Flat Glass Piece Into A Glass Component And Shaping Tool For Use In The Method”, international application number PCT/EP2020/077811, filed in the European Patent Office on Oct. 5, 2020, which claims priority to and the benefit of the non-provisional patent application titled “Process For Forming Flat Glass Into A Glass Component And Forming Tool For Use In The Process”, non-provisional patent application number DE102019216893, filed in the German Patent Office on Oct. 31, 2019. The specifications of the above referenced patent applications are incorporated herein by reference in their entirety.

### FIELD OF THE INVENTION

The invention relates to a method of forming a flat glass into a glass component comprising a base area and provided with a number of formations for forming surface structural elements which can be felt by a user. It further relates to a forming tool for use in such a process.

Flat control elements, such as touch screens or touch pads, are increasingly used in motor vehicles as a means of entering user instructions, for example to control navigation and entertainment systems and the like. Such touch controls can be designed, for example, as simple, linear touch controls, so-called “touch sliders”, which can be arranged in any shape in principle, for example as a straight or curved line. When used in a motor vehicle, this can, for example, implement operation in a predefined direction. In addition, such touch control elements can also be designed as flat control elements, which are used, for example, to control an input pointer of an optical input device in two axis directions. Such touch controls intended for use in the cockpit of a motor vehicle are known, for example, from DE 10 2012 020 570 B4 and DE 10 2016 122 972 A1.

### BACKGROUND

The known touch control elements are usually designed as flat control elements with a flat, “straight” surface, using touch screens or touch panels that are known per se. In the design of modern motor vehicle cockpits or interiors, however, there is an—increasing desire, both for reasons of design or styling and for functional reasons, namely in the sense of providing contours that can be haptically grasped by the user, to design such display and/or control elements as elements with small or large contours, which, for example, can be harmoniously integrated into the design and functional language of the vehicle's interior design or which, in terms of their design, pick up on the spatial shapes familiar to the user, for example of a rotary control, and make them recognizable. For the same reasons, the use of glass as a surface material for such display and/or control elements is also desirable, inter alia, because in this way a particularly high-quality overall impression of the interior design of the vehicle can be achieved for the user.

### SUMMARY OF THE INVENTION

When using glass as a surface material for such contoured display and/or control elements, however, it must be taken into account that glass is subject to certain boundary conditions with regard to shaping or contouring due to the material. In particular, glass can be formed into almost any shape by certain pressing or casting processes. However, soda-lime glass must be heated to temperatures far above 800° C., and the pressing tool determines the surface quality of the component. However, such pressing processes are hardly an option for larger components. In addition, a high degree of mechanical stability and resilience is particularly important for use as a control element that is exposed to repeated or frequent access.

The invention is therefore based on the task of specifying a method for the production of a glass component suitable in particular as a display and/or operating element in the interior of a motor vehicle by forming a flat glass element, with which a particularly high mechanical load-bearing capacity of the glass component or moulded part can be achieved in a particularly simple and reliable manner even with comparatively complexly configured structural elements. Furthermore, a forming tool particularly suitable for use in such a process is to be specified.

With regard to the process, this task is solved according to the invention by heating the flat glass in a forming tool to soften the material and, before or during the forming which thereby occurs, placing it on a number of forming plungers corresponding to the intended formations, the glass material taking up the contour of the base of the forming tool between the forming plungers to form the base area.

The process according to the invention is thus specifically distinguished from—processes that have been customary in such a context up to now, in particular deep-drawing processes, in which forming tools with depressions or recesses corresponding to the intended structural elements are used in the support base. In such known processes, the flat glass is placed on the bottom area of such a forming tool for forming. After heating and the resulting softening of the material, the glass can then flow into the depressions or hollows and, after cooling and hardening, form the desired structure or spatial shape on the surface.

Surprisingly, however, it has turned out that the structures produced in this way have a comparatively unexpectedly low wall thickness, especially in the area of their side walls, so that an increased risk of breakage must be assumed. This is particularly significant if the structural elements moulded onto the base surface not only have a decorative or aesthetic function, but are also to be used functionally, i.e. as an operating element. This can be the case, for example, if such structural elements are to be designed in the manner of rotary controls. The increased physical contact with the structural element associated with such an intended use, for example as a result of touch in the case of a touch element, actually requires increased break resistance in order to ensure the desired longevity of the glass component.

In order to take this into account, the process is specifically designed to produce a comparatively high wall thickness during the forming of the glass, also in the wall areas of the formed-on structural elements, which causes the desired high mechanical stability. As it turned out quite surprisingly, such an increased wall thickness can be achieved by providing the forming tool in the manner of an “inverse forming process” with profile plungers instead of recesses or depressions arranged at the positions of the intended structural elements, on which the flat glass can be placed before forming or on which it comes to rest when the material begins to soften and is thus formed. During further forming, the softened glass can then sink between the profile stamps and take up the contour of the bottom of the forming tool.

As has turned out quite surprisingly, the desired production of sufficiently thick walls in the area of the side walls of the structural elements can be particularly favored in this way. Advantageously, during the forming of the glass material, a transverse flow of material is generated towards the side flanks of the forming plungers. Thus, an enrichment of the material in these areas can be achieved, which directly favors the desired reinforcement of the side walls. Such a material crossflow can be adjusted and promoted in particular by setting suitable temperature profiles in the forming tool. This makes use of the knowledge that the softened, flowing glass material is locally cooled or at least heated to a lesser extent compared to the rest of the glass during (initial) contact with the forming punches, so that the flowability of the material in the planar or front area of the formations or the structural elements formed by them is reduced compared to the rest of the glass material. This results in a relatively increased flow effect from the comparatively warmer or hotter regions of the base surface, and the desired transverse flow of material is produced. In a particularly advantageous further development, the forming tool is heated less in the area of its forming plungers during the forming of the glass material than in the base areas in between.

In an alternative or additional advantageous further development, this effect can be used particularly effectively by cooling the forming tool in the area of the side walls or side flanks of the formations selectively and as required. In this way, the flowability of the material can be specifically reduced in these areas, so that a material outflow can be kept particularly low.

With regard to the forming tool for use in a process of the aforementioned type, the aforementioned task is solved with a tool base to which a number of rising forming plungers are moulded. The forming tool is thus designed in the manner of an “inverted version” so that when the glass element is formed, it is first placed on the upper surfaces of the forming plungers and then, after the material has softened, is drawn over the entire surface “into the mould” towards the tool base between the forming plungers.

In order to ensure a particularly high wall thickness in the area of the side surfaces of the structural elements in a particularly reliable manner with such an arrangement, the forming tool is advantageously designed to create a transverse flow towards the forming plungers in the glass to be processed, so that the material collects in the area there and thus leads to a higher material thickness. For this purpose, the tool base of the forming tool is advantageously heatable, preferably independently heatable in segments.

In order to further promote this material crossflow, in an additional or alternative advantageous further development, the tool bottom of the forming base is designed with low friction at least in sections, for example with a particularly smooth or polished surface, and/or provided with a friction-reducing coating, preferably of graphite or boron nitride.

The advantages achieved with the invention consist in particular in the fact that, due to the design of the forming tool as an “inverted tool” and due to the design of the forming process in such a way that the flat glass first comes into contact with the forming plungers during forming, so that the glass material for forming the base area between the forming plungers takes up the contour of the base of the forming tool, particularly large wall thicknesses at the side walls of the structural elements can be achieved in a particularly simple and reliable manner. As a result, the moulded glass component has a particularly high mechanical load-bearing capacity and breaking strength even for comparatively complex surface structural elements and also for structural elements intended directly as operating elements, for example as rotary actuators.

### BRIEF DESCRIPTION OF THE DRAWINGS

An embodiment of the invention is explained in more detail with reference to a drawing. Shown therein is:

FIG. 1 illustrates a forming tool of known design in perspective view.

FIG. 2 illustrates a perspective view of a forming tool according to the invention.

FIG. 3 illustrates a cutout of a sectional view of a formed glass component.

FIG. 4A illustrates a cutout of a sectional view of a glass element placed on a forming tool as shown in FIG. 2 before forming.

FIG. 5A illustrates a cutout of a sectional view of a glass element placed on a forming tool as shown in FIG. 2 after forming.

### DETAILED DESCRIPTION OF THE INVENTION

Identical parts are marked with the same reference signs in all figures.

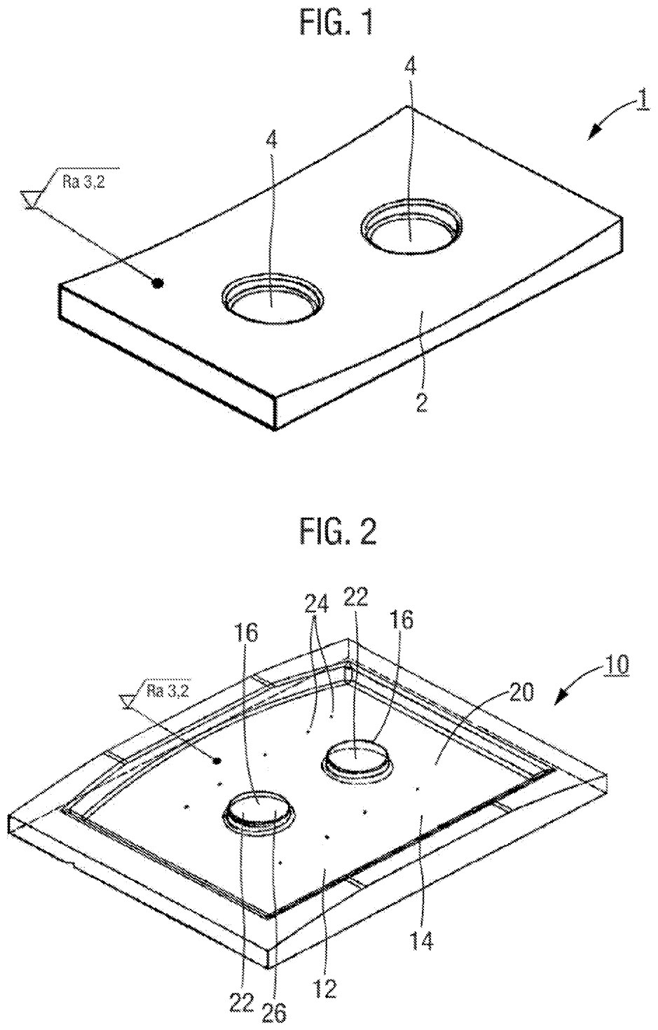

The familiar forming tool 1 shown in FIG. 1 and the forming tool 10 according to the present invention, shown in FIG. 2 together with a formed glass component 12, are each used to form or mould a flat glass provided as a starting or intermediate product into a formed glass component 12 adapted to a specific application. The starting product is referred to in the present case as “flat glass” since it is a glass element with a laterally extended surface. This can be “flat” in the sense of level, but also curved or provided with a pre-curvature. In the embodiment example, the shaped glass component 12, which is to be produced from the flat glass by suitable forming, is intended for use as a touch control element in a modern motor vehicle cockpit and for this reason, in particular for providing contours which can be haptically detected by the user, is to be designed as a contoured glass component 12 with a base area 14 to which a number of formations 16 intended for forming surface structural elements which can be felt by a user are formed. In the embodiment example, a particularly preferred embodiment of the glass component 12 is shown in which the formations 16 are intended for the user to perceive the appearance and functionality of rotary controls or dials; accordingly, in the present case, the formations 16 are in the form of cylindrical discs with a substantially round cross-section. Of course, the shaped and contoured glass component 12 can also be designed and conceived for other purposes and equipped with other surface structure elements adapted thereto.

The forming tools 1, 10 shown in FIGS. 1, 2 are provided for producing the glass component 12 by forming the flat glass element. The forming tool 1 according to FIG. 1, which is known per se, is designed for carrying out a deep-drawing process which is customary in this context. For this purpose, the forming tool 1 comprises a number of recesses or depressions 4 in its support base 2 corresponding to the structural elements provided. For forming, the flat glass is placed on the support base 2 of the forming tool 1. Subsequently, the glass is heated to temperatures above the material softening point so that the glass material begins to flow. The glass can thus flow into the depressions 4 or hollows and, after cooling and hardening, form the desired structure or spatial shape on the surface.

In comparison, the forming tool 10 according to the invention shown in FIG. 2 is in the form of an “inverse” forming tool. It comprises a tool base 20 to which a number of rising forming plungers 22 are moulded. The number, positioning and shape of the forming plungers 22 are suitably selected to match the formations 16 provided for the glass component 12. In addition, a number of suction or vacuum channels 24 are arranged in an integrated manner in the tool base 20, in particular between the forming plungers 22, which in turn are connected to a suction or vacuum system which is not shown in greater detail. In this embodiment of the forming tool 10, which is considered to be inventive on its own, the forming of the flat glass into the glass component 12 is carried out by first placing the flat glass on the platform-like upper sides 26 of the forming plungers 22 and/or on a circumferential supporting rim and then heating it to soften the material. In particular, it is ensured that the flat glass first comes to rest on the platform-like upper sides 26 of the forming plungers 22 in connection with the forming, so that it is more or less cooled in these areas compared to the rest of the glass material and its flowability is reduced accordingly. During further forming, the glass material for forming the base area 14 between the forming plungers 22 adopts the contour of the tool base 20 of the forming tool 10. To support this, a suction vacuum is set as required between the tool base 20 and the glass mass via the vacuum channels 24, which further promotes the glass mass to adhere to the surface of the tool base 20.

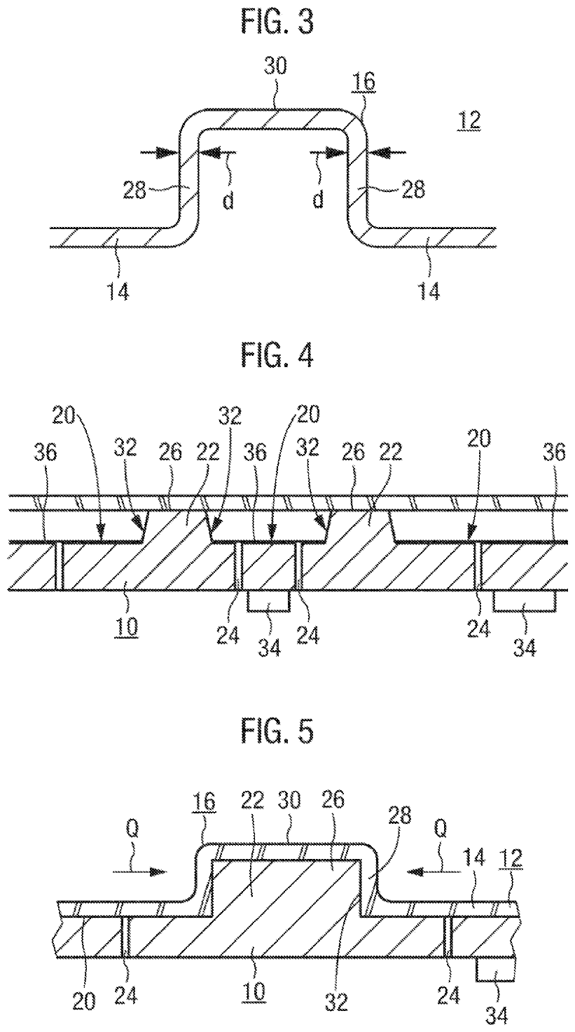

The glass component 12 produced during the forming process is shown partially in cross-section in FIG. 3. The base area 14 is connected to the respective front panel 30 in the area of the respective forming 16 via its respective side wall 28. As has turned out completely surprisingly, by the concept of “inverse forming” according to the invention by means of the forming tool 10 it can be achieved with comparatively simple means and nevertheless particularly reliably that the resulting side walls 28 of the formations 16 have a comparatively large wall thickness d and thus a comparatively high mechanical load-bearing capacity and breaking strength.

This desired increase in the load-bearing capacity and breaking strength of the glass component 12 is also further reinforced in the region of the formations 16 by setting a comparatively large wall thickness d of the side walls 28, in that, in an embodiment regarded as independently inventive, a transverse flow of material is produced towards the side flanks 32 of the forming plunger 22 during the forming of the glass material. In this way, the glass material is selectively enriched in these areas, which directly results in an increase in the thickness or wall thickness d of the side walls 28 produced in these areas.

To create or promote this material crossflow, the forming tool 10 can be heated locally and independently in segments in the area of its tool base 20. Individually controllable heating or cooling elements 34 are arranged on the tool base 20 for this purpose. By means of these, a suitable temperature profile, in particular a suitable temperature gradient, can be set in the tool base 20 and at the forming plungers 22 during forming, which favors an accumulation of the material in the region of the forming plungers 22—and thus precisely the desired material cross-flow—by means of a suitable change in the viscosity or flowability in the glass material to be processed. On the other hand, the tool base 20 is also provided with a friction-reducing coating 36, which also further increases the flowability of the glass material in the transverse direction.

FIG. 4 shows a partial cross-section of the flat glass placed on the platform-like upper sides 26 of the forming plungers 22 before it is formed. FIG. 5, on the other hand, shows—also in partial cross-section—the flat glass being formed into the glass component 12. The transverse flow of material towards the forming plungers 22 is symbolized by the arrows Q.

### LIST OF REFERENCE SIGNS

1 forming tool
2 support base
4 depression
10 forming tool
12 glass component
14 base area
16 formation
20 tool base
22 forming plunger
24 vacuum channel
26 upper side
28 side wall
30 front panel
32 side flank
34 heating or cooling element
36 coating
d wall thickness
Q arrow

1-6. (canceled)

7. A method of forming a flat glass into a glass component, the glass component comprising a base area and provided with a number of formations intended to form surface structural elements which can be felt by a user, in which method the flat glass is heated in a forming tool so as to soften the material and, before or during the forming which thereby occurs, the flat glass comes to rest on a number of forming plungers corresponding to the intended formations, wherein the glass material assumes the contour of the base of the forming tool between the forming plungers for forming the base area, wherein during the forming of the glass material a transverse flow of material towards the side flanks of the forming plungers is produced in that during the forming of the glass material the forming tool is heated less in the region of its forming plungers than in the bottom regions therebetween.

8. The method of claim 1, wherein the transverse flow of material is promoted by the use of a forming tool, the tool base of which is provided at least in sections with a friction-reducing coating, preferably graphite or boron nitride.
